(19) United States
(12) Patent Application Publication
(10) Pub. No.: US 2008/0220991 A1
(43) Pub. Date: Sep. 11, 2008

(54) CONTACTING SURFACES USING SWELLABLE ELEMENTS

(75) Inventors: Jeremy Buc Slay, Fort Worth, TX (US); Steven G. Streich, Duncan, OK (US)

Correspondence Address: FISH & RICHARDSON P.C., P.O. BOX 1022, MINNEAPOLIS, MN, 55440-1022, US

(73) Assignee: HALLIBURTON ENERGY SERVICES, INC. - DALLAS, Houston, TX (US)

(21) Appl. No.: 11/682,697

(22) Filed: Mar. 6, 2007

(51) Int. Cl. C09K 3/00

(52) U.S. Cl. 507/203; 507/269; 524/847; 977/742

(57) ABSTRACT

The present disclosure includes a system and method contacting surfaces using swellable elements. In some implementations, an apparatus includes a tubing and a polymer compound. The tubing includes surface and is configured to longitudinally conduit fluid. The polymer compound is adjacent at least a portion the surface of the tubing and operable to expand at least in a radial direction in response to at least an activating agent. The polymer compound comprises nano particles with an aspect ratio at least 2.5.

### TECHNICAL FIELD

This disclosure relates to fluid production and, more particularly, to contacting surfaces using swellable elements.

Expandable packing elements (e.g., plug assemblies, bridge plugs, drillable packers, inflatable packers, swellable packers, rotational locking sealing packers, and other example packing elements) in combination with other elements are selectively located within a well bore to isolate one or more of the production zones. As for expandable tubular elements, the expandable elements are located in the well bore and radially expanded to apply a radial force against the well bore such as a liner, casing, open hole or other elements defining the wall of the well bore. In doing so, the tubular element may substantially seal against the flow of fluid along an annulus formed by the tubing and the well bore and, thus, present the flow of fluid to or from the isolated zones. The swellable element can also be attached to the ID of the a device so that the compound expands radially inwards as it swells. In either case, the radial swelling can also provide an anchoring function to maintain the location of devices that are in contact with the swelling element. In some case, the expandable element includes a polymer compound that expands in response to an activating agent (e.g., oil, water, drilling mud, gas). Though, during completion and production operations, the expandable elements are frequently subjected to high temperature and high pressure in oil and gas wells which has caused damage or deterioration of the expandable elements.

### SUMMARY

The present disclosure includes a system and method sealing subterranean zones. In some implementations, an apparatus includes a tubing and a polymer compound. The tubing includes surface and is configured to longitudinally conduit fluid. The polymer compound is adjacent at least a portion the surface of the tubing and operable to expand at least in a radial direction in response to at least an activating agent. The polymer compound comprises nano particles with an aspect ratio at least 5.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating a well bore system using swellable packers in accordance with some implementations of the present disclosure;

FIG. 2A-C illustrate one example of a swellable packer in accordance with some implementations of the present disclosure;

FIG. 3 is a flow diagram illustrating an example method for producing a swellable element including nano particles; and

FIG. 4 is a flow diagram illustrating an example method for using the swellable element of FIGS. 2A and 2B in a well bore.

Like reference symbols in the various drawings indicate like elements.

### DETAILED DESCRIPTION

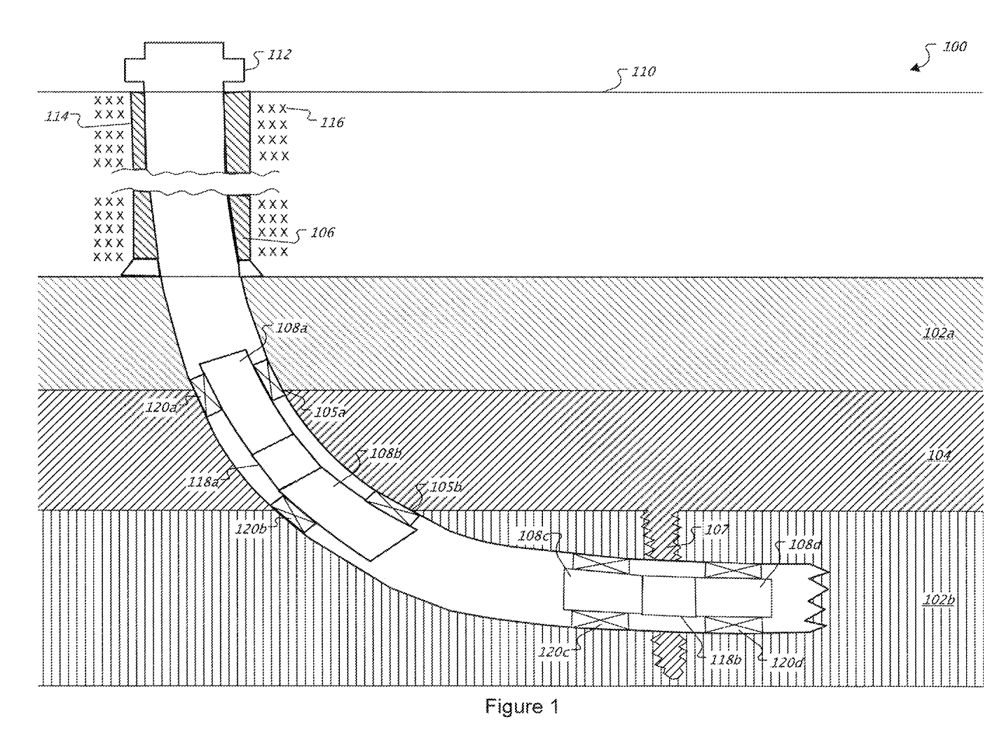

FIG. 1 is a cross-sectional view of one example of a well system 100 that includes swellable elements having nano particles. Nano particles may include one or more of the following: carbon nanotubes (e.g., single-walled carbon nanotubes, multi-walled carbon nanotubes), carbon nano fibers, nano clays, or other particles having at least one dimension between 0.5 nanometer (nm) and 500 nms. For example, system 100 may use swellable material embedded with or otherwise including nano particles to substantially form a barrier with non-production zones. In some examples, the system 100 may use material embedded with or otherwise including nano particles to anchor an apparatus. In certain implementations, the nano-particle swellable material expands in at least one dimension in response to an activating agent (e.g., water, oil, drilling mud, gas), i.e., the final compound containing nano-particles is swellable. The nano-particle reinforced swellable material may substantially be used in a number of swellable applications, downhole, on the surface, subsea, or otherwise. For example, the nano particle filled material may be used as a barrier configured to contact a wall of the well bore to substantially prevent or otherwise impede the flow of fluid between a first zone 104 (e.g., contamination zone, a different production zone) and a production zone 102. In general, fluid may include gas, liquid, and/or a combination (e.g., a supercritical form). In combination or alternatively, the nano particle swellable material may be used with other downhole devices and other equipment (e.g., anchor). In summary the nano-particle swellable material may be used with various downhole equipment without department from the scope of the disclosure. For example, the nano-particle swellable material may be used with mechanical packers and/or hydraulically packers. The following description discusses the nano-particle swellable material in the context of swellable materials, but the nano-particle swellable material may be used in other apparatuses that do not include or are combined with swellable materials.

In some instances, a barrier is formed over a flow gap between two zones using swellable material in combination with tubing. In this case, the swellable material may react to an actuating agent (e.g., drilling fluid, hydrocarbon, water, brine, gas) and, as a result, expand the swellable material in at least one dimension (e.g., radial). In some implementations, the swellable material may be mechanically and/or hydraulically assisted or solely mechanical and/or hydraulically. To enable conduction of fluid after expansion, the conventional swellable material is often applied to a downhole tubular such as a pipe, a liner, a casing, or other elements configured to conduct fluid. Though, the use of conventional swellable material in drilling operations may result in failure. For example, the conventional swellable material may have a problem with swell, degradation, abrasion, fatigue, extrusion, bonding to steel, tearing, and/or other failures. In addition, conventional swellable material might have a relatively high uncured viscosity, and as a result, the high viscosity often limits manufacturing of swellable elements. For example, conventional swellable materials may have poor flow during mandrel wrap, compression, injection, extrusion, and/or transfer molding. In some instances, a polymer compound may be embedded with nano particles to enhance, maximize, or otherwise increase one or more properties such as mechanical, thermal, physical, chemical, and processing properties. For example, the enhanced properties may include on or more of the following: reduced processing viscosity, impact strength, stress relaxation resistance, extrusion resistance, compression set properties, less hysteresis, less heat build up, reduced creep, abrasion resistance, and/or other properties. In doing so, the lifetime and/or performance of the swellable material may be increased as compared with conventional swellable material.

In some implementations, system 100 may includes the production zones 102a-b, the first zone 104, a well bore 106, and swellable elements 108a-b. The production zone 102 may be a subterranean formation including resources (e.g., oil, methane, water). First zone 104 may include contaminants that, if mixed with the resources, may result in requiring additional processing of the resources and/or make production economically unviable. Swellable elements 108 may bridge flow gaps and, as a result, may substantially prevent fluids (e.g., oil, natural gas, water CO₂) from flowing to and/or from well bore 106. Indeed, swellable elements 108 may substantially prevent or otherwise decrease contamination and/or loss of at least a portion of the resources that may otherwise be produced from the production zone 102. In some implementations, the swellable elements 108 may comprise an anchor for securing an apparatus within the well bore 106.

Turning to a more detailed description of the elements of system 100, the well bore 106 extends from a surface 110 to the production zone 102. The well bore 106 may include a well head 112 that is disposed proximate to the surface 110. The well head 112 may be coupled to a casing 114 that extends a substantial portion of the length of the well bore 106 from about the surface 110 towards the production zones 102 (e.g., hydrocarbon-containing reservoir). In some implementations, the casing 114 extends proximate to the production zone 102a to form an open hole completion. In some implementations, the casing 114 may extend to proximate the terminus of the well bore 106 (not illustrated) to form a closed completion. Some or all of the casing 114 may be affixed to the adjacent ground material with a cement jacket 116. In some implementations, the casing 114 comprises a metal. The casing 114 may be configured to carry a fluid, such as air, water, natural gas, or to carry an electrical line, tubular string, or other elements. In some implementations, the well 106 may be completed with the casing 114 extending to a predetermined depth proximate to the production zone 102. In short, the well bore 106 initially extends in a substantially vertical direction toward the production zone 102.

In addition, the well bore 106 includes an angled or radiused portion for intersecting the well bore 106 with the production zone 102. In other words, the well bore 106 extends downwardly in a substantially vertical direction from the surface 110 to a predetermined distance and then curves at a desired location. The curved portion may be formed having a generally uniform or straight directional configuration or may include various undulations or radiused portions to intersect the production zone 102 and/or to accommodate various subterranean obstacles, drilling requirements or characteristics. Indeed, the well bore 106 intersects, penetrates and continues through the production zone 102b. Prior to the intersection, the well bore 106 may pass through several formations non-production formations such as the first zone 104. To prevent contamination and/or loss of resources, system 100 may use swellable elements 108 to substantially form a barrier with the first zone 104.

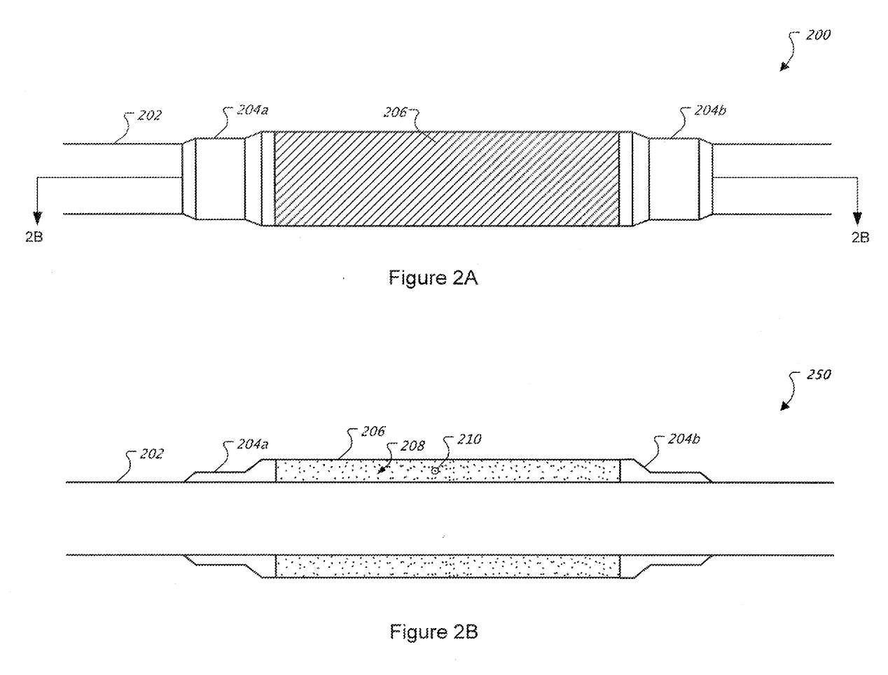

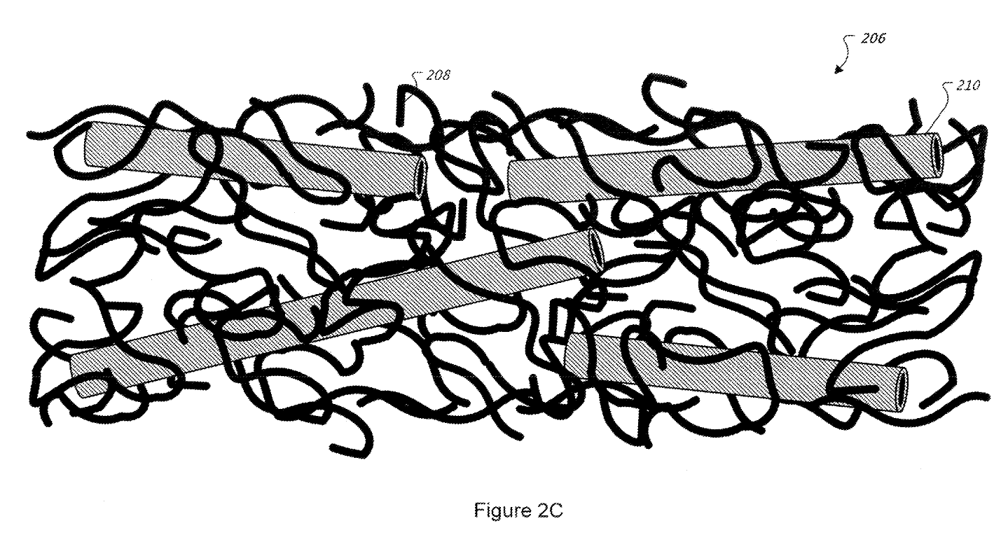

By selectively positioning the swellable elements 108 and expanding the swellable elements, system 100 may substantially prevent the flow of fluid to, from, and/or through the first zone 104. In the illustrated implementation, the swellable element 108a is positioned to overlap boundaries 105a and 105b of the first zone 104. In addition, the swellable element 108b is positioned to overlap a fracture 107 permeating from the first zone 104. Generally, the swellable elements 108 may bridge gaps between metal parts (e.g., casing, liners), between metal parts and subterranean formations, and/or subterranean formations. The swellable element 108 expands at least in one dimension in response to an activating agent. In addition to the agent, the swellable elements 10 may additional be expanded by any appropriate mechanism such as mechanical, electrical, hydraulic, and/or other mechanism. In the illustrated implementation, the swellable elements 108 include tubing 118 coupling two swellable elements 120. In some implementations (not illustrated), the swellable element 108 may comprise a single swellable element 120, two swellable elements 120 directly coupled, or two swellable elements 120 coupled using multiple segments of tubing 118. The outer surface of the tubing 118 and the wall of the well bore 106 (e.g., open hole, casing, liner) may form an annulus. Though, the swellable elements 120, when actuated, may substantially block or prevent the conduction of fluid from one side of the swellable element 120 to the other side of the swellable element 120. In other words, the swellable elements 120 may form barriers with the wall of the well bore 106 that substantially prevent the conduction of fluid though the annulus of the tubing 118. The swellable elements 120 may include a polymer compound and nano particles (disclosed in more detail in reference to FIGS. 2A and 2B). For example, the polymer compound may include elastomers, thermoplastic elastomer, thermoplastic vulcanates, and/or other thermosets or polymer compounds. In connection with substantially isolating the first zone 104, the interior of the tubing 118 may conduct fluids such as oil, methane, and/or other resources through the swellable elements 108.

FIGS. 2A-C illustrate an example swellable element 120 of FIG. 1 for substantially preventing fluid flow to, from, and/or through first zone 104. The illustrated swellable element 120 is for illustration purposes only. System 100 may include all, some, or different aspects of the swellable element 120 without departing from scope of this disclosure. Moreover, system 100 may use any other elements for performing the same functions as the example swellable element 120.

Referring to FIG. 2A, the swellable element 120 includes tubing 202, end rings 204, and swellable material 206. The tubing 202 may provide a fluid conduit that conducts fluids from one end to the other end of the tubing 202. Conventionally, the tubing 202 is substantially cylindrical and may be manufactured from any suitable material (e.g., steel, fiberglass). The end rings 204 may be coupled to the tubing 202 using any suitable process (e.g., welding, fasteners, frictional fits). The swellable material 206 is formed, applied, or otherwise positioned on the outer surface of the tubing 202. The polymer compound attachment to the substrate can rely on mechanical and/or chemical interactions. The swellable elements can be used with or without end rings. In some implementations, the swellable material 206 is substantially cylindrical. The swellable material 206 includes a first and second end such that an end ring 204 is adjacent each end of the swellable material 206.

The swellable material 206 includes a retracted state and an expanded state (not illustrated). The swellable material 206 in the expanded state has a volume greater than the volume in the retracted area. In some implementations, the end rings 204 may maximize, enhance, or otherwise increase the expansion of the polymer compound in the radial direction. In this case, the swellable element 120 may be selectively positioned in the well bore 106 in the retracted state and, after reacting with an agent, the swellable material 206 may expand to form a barrier between the tubing 202 and the wall of the well bore 106. As discussed above, the barrier may substantially isolate the first zone 104.

FIG. 2B illustrates a view of the swellable element 120 along the line 2B-2B in accordance with some implementations of the present disclosure. In particular, the swellable material 206 includes a polymer compound 208 and nano particles 210. In general, the polymer compound 208 typically expands or otherwise swells in response to an actuating agent (e.g., hydraulic oil, water, drilling fluids). As mentioned above, the polymer compound 208 may expand in one or more directions (e.g., radially). In some implementations, the polymer compound 208 may absorb the actuating agent and/or chemically react with the actuating agent. In the case of reaction, the actuating agent may break at least a portion of the cross-link bounds in the polymer compound 208. The polymer compound 208 may include one or more of the following materials: thermoplastics, ThermoPlastic Elastomer (TPE), ThermoPlastic Vulcanizate (TPV), Nitrile Butadiene Rubber (NBR), Hydrogenated Nitrile Butadiene Rubber (HNBR), Chloroprene Rubber (CR), Fluoroelastomer (FKM), Tetrofluoroethylene/polypropylene rubber (FEPM), Ethlenepropylenediene rubber (EPDM), Perfluorinated elastomer (FFKM), carboxylated versions of acrylonitrile containing polymers, carboxlated versions of butadiene containing polymers, or other swellable materials.

As mentioned above, the swellable material 206 may include nano particles 210. Nano particles 210 may be 500 nm or less in at least one dimension. For example, the nano particles 210 may be tubular (e.g., multi-walled carbon nanotubes) having a 10 nm or less diameter with a length 200 nm or greater. Nano particles 210 may include one or more of the following shapes: plates, spheres, cylinders, tubes, fibers, 3D structures, linear molecules, molecular rings, branched molecules, crystalline, amorphous, symmetric, itactic, or any other shapes. In some implementations, the nano particles 210 have an aspect ratio of at least 5. In some implementations, the aspect ratio may be determine by dividing the largest dimension by the smallest diameter. In the case of CNTs, the aspect ratio may be determine by dividing the length of the cross-sectional diameter. In the case of nano clays, the aspect ratio may be determined by dividing the diameter by the thickness. Nano particles 210 may include one or more of the following elements and/or molecules; polymers, carbon, silica, calcium, calcium carbonate, inorganic clays, minerals, or other nano-sized materials. The nano particles 210 may be added to the polymer compound in one or more of the following processes: polymerization, mixing, compounding, grafting precipitation, and/or other processes. For example, the nano particles 210 may be mixed with the polymer compound 208 prior to polymerization or grown into the polymer matrix of the compound 208 during polymerization.

To enhance or maintain properties in comparison to conventional swellable material, the polymer compound 208 requires significantly less filler, i.e., nano particles 210 with high aspect ratio, as compared to conventional nano sized fillers such as carbon black and silica or larger glass fiber and carbon fiber. For example, the polymer compound 208 may include 2% to 30% by weight of nano tubes 210 in comparison to 20% to 50% of conventional filler to at least maintain one or more properties. In this case, the processing viscosity of a 90 duro nano reinforced polymer compound 208 (ML of 19 ip) is significantly lower compared a more conventional 90 duro carbon black filled compound (ML of 36 ip). As a result of a lower viscosity, manufacturing the swellable element 120 may be easier. In some implementations, a decrease in the amount of filler typically corresponds to an increase in swellability. In other words, less filler as in the case of using the nano particles 210 may increase the amount of the polymer compound 208 in the swellable element 120. The increased amount of polymer compound 208 may increase the swellability of the swellable material 206. In this case, the polymer compound 208 including the nano particles 210 may swell greater than 200% in at least one dimension. In combination or alternatively to increasing the swellability, the nano reinforced compound 208 may withstand higher pressure and/or increase the anchor force in comparison to conventional swellable material. For example, a conventional compound that swells 100% in its free state may create 60 psi barrier force when swollen in a confined space and a nano reinforced compound that swells 150% in its free state may create a 75 psi barrier force when swollen in a confined space. Therefore, the nano reinforced material, which is more polymer rich, swells more creating a higher barrier force allowing it to hold more pressure before leaking.

In contrast to conventional filler, the nano particles 210 typically have a high aspect ratio which can range from 10 to 1,000 and in some cases is up to 1,000,000. Future manufacturing techniques may make the aspect ratio greater than 1,000,000. In some implementations, the aspect ratio is proportional to the largest dimension divided by the smallest dimension. In the case of CNTs, the aspect ratio may be determine by dividing the length by the cross-sectional diameter. In the case of nano clays, the aspect ratio may be determined by dividing the diameter by the thickness. In the case of carbon nanotubes, the aspect ratio is usually within the range 10 to 10,000 by comparison to the conventional filler carbon black which has an aspect ratio approximately equal to 1.

In some implementations, the nano particles 210 may be chemically functionalized. For example, a chemical group may be added to the nano particles 210 to add and/or enhance properties of the nano particle and produce the final compound 210. The chemical group may increase the affinity the nano particles 210 have for the polymer compound 208 by adding a reactive site to at least a portion of the nano particles 210. In general, the functionalization of the nano particles 210 may be customized to impart specific properties and/or to react with different parts of the polymer compound 208 (e.g., polymer matrix, cure network). In some implementations, the functionalization of the nano particles 210 may enhance or otherwise increase interaction with the crosslinked elastomer matrix formed by the polymer compound 208 and, thus, may provide certain properties to the swellable material 206. The chemical crosslinks may include covalent, non-covalent, ionic, van der Waals, and other types of interactions.

Referring to FIG. 2C, the swellable material 206 is illustrated one implementation in accordance with the present disclosure. As discussed, the polymer compound 208 may comprise several different types of compounds, and the nano particles 210 may comprise several different types of particles. In the illustrated example, the polymer compound 208 is a polymer matrix 208, and the nano particles 210 comprise CNTs 210. While illustrated as CNTs, the nano particles 210 may comprise other nano particles with substantially large aspect ratios (e.g., greater than 5).

For example, the nano particles 208 may comprise one or more of the following: carbon nanotubes (CNT), carbon nanofibers (CNF), or nano clay. In general, CNTs comprise hollow tubes comprising carbon. CNTs may include single wall nanutubes (SWNTs) with a diameter approximately 1 nm and/or multiwall nanotubes (MWNTs) with a diameter approximately 10 nm. The lengths of CNT typically range from 100 nm to 10,000 nm and some processes have grown them to the millimeter (mm) scale in length. CNTs can also be shorter such as by chemically cutting the tubes (e.g., 5 nm length). CNFs are solid structures (not a tube) are comprises of carbon. The diameters of CNFs may have random diameters ranging from 50 nm to 500 nm and are typically 1000 nm to 0.1 mm long. As with CNTs, CNFs may be fabricated to longer lengths. Nano clays are platelet structures that are about 1 mm thick and 70 to 150 nm in diameter. Nano clays may be chemically modified to maximize, enhance, or otherwise increase dispersion and exfoliation. Aspect ratios of nano clays may range between 70 to 150.

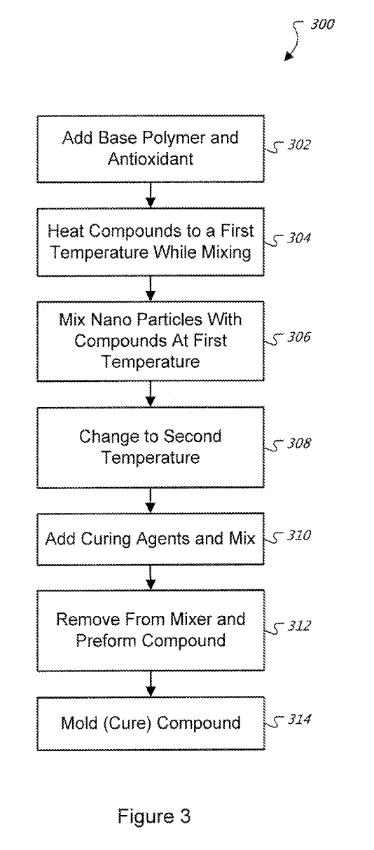

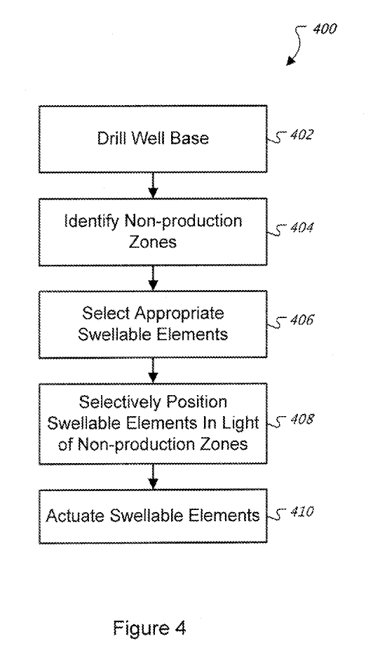

FIGS. 3 and 4 are flow diagrams illustrating example methods 300 and 400 for manufacturing and implementing polymer compounds including nano particles. The illustrated methods are described with respect to well system 100 of FIG. 1, but these methods could be used by any other system. Moreover, well system 100 may use any other techniques for performing these tasks. Thus, many of the steps in these flowcharts may take place simultaneously and/or in different order than as shown. The well system 100 may also use methods with additional steps, fewer steps, and/or different steps, so long as the methods remain appropriate.

Referring to FIG. 3, method 300 begins at step 302 where a base and possibly an antioxidant are added together. A simple example may include the HNBR polymer Therban A 3907 (100 parts) and the antioxidant as Stangard 500 (0-4 parts). At step 304, the compound is mixed and heated to a first temperature. In the example, the compounds identified above may be heated during the mixing process to some temperature below the degradation temperature. In connection with mixing the compound, nano particles are mixed with the compound at the first temperature at step 306. Conventionally, a filler (e.g., carbon black) is added to the compounds to ad rigidity to the rubber. As discussed above, nano particles may be added to the mixture in a reduced amount but enable the properties of the rubber to be maintained or enhanced in comparison to conventional filler. In the identified example, carbon black (e.g., SRF N-762) may be added at 50 to 100 parts to the above identified compounds to produce a sufficiently rigid compound. In comparison, nano particles may be added at about 5-30 parts and provide substantially the same rigidity to the rubber. In fact, the reduced amount of filler may enhance the swellability of the rubber. In addition, various mixing techniques may be used such as banbury, intermeshing rotors, two or more roll mill, single, twin or multi screw extruder, solution mixing, and/or other techniques. Once the nano particles are sufficiently dispersed in the mixture and/or sufficiently exfoliated, the mixture temperature is changed to a second temperature for the addition of the curing agents, at steps 308 and 310. In the example, the mixture may be heated to 175° C. to cure. Prior to curing of the polymer compound, the compound is removed from the mixer and preformed at step 312. For example, the polymer compound may be formed to the outer surface of a tubing to form as swellable element as discussed above in FIG. 2B. In the cured compound, the nano particles may be dispersed at a lower concentration that conventional fillers. For example, the nano particles may dispersed at 10 parts per hundred of rubber (phr) in comparison to a conventional filler that may be dispersed at 75 phr.

Referring to FIG. 4, method 400 begins at 402 where a well bore is drilled. The well bore may be a single vertical, a single horizontal, a multilateral, and/or a combination of the foregoing. For example, the well bore 106 may be drilled through multiple zones including production zones 102 and first zone 104. In connection with drilling the well bore, one or more non-production zones may be identified at step 404. In the example, the non-production zones (e.g., first zone 104) may be identified including Measurements While Drilling (MWD) instruments on the bit string and/or logging the well bore 106 after drilling. At step 406, appropriate swellable elements are selected. In the example, swellable elements 108 of varying lengths may need to be selected or assembled based, at least in part, on the measurements of the well bore 106. In some cases, the swellable element 108 may include two swellable elements 120 directly coupled or swellable elements 120 coupled using one or more segments of tubing 118. As illustrated in FIG. 1, both swellable elements 108 include two swellable elements 120 and one segment of tubing 118. At step 408, the swellable elements are selectively position in the well bore based, at least in part, on the identified non-production zones. Again returning to the example, the swellable elements 108 are selectively positioned at the boundaries 105a and 105b and the fracture 107 to substantially for a barrier with the first zone 104. In some implementations, the swellable elements are positioned using a working string. The swellable elements are actuate at step 410 to substantially prevent the flow of fluid to or from the non-production zones. In the example, the swellable elements 208 are expanded forming a barrier with the swellable elements 120 and the wall of the well bore 106 at the boundaries 105a and 105b and the fracture 107.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are possible without departing from the spirit and scope of this disclosure.

What is claimed is:

1. A method, comprising:
selectively positioning in a well bore a swellable material, the swellable material including nano particles with an aspect ratio greater than 2.5; and
exposing the swellable material to a fluid to expand the swellable material at least in one dimension to substantially contact a surface.

2. The method of claim 1, wherein the contact comprises substantially impeding flow of the fluid.

3. The method of claim 1, wherein the surface comprises an inner diameter of a tubular or an outer diameter of a tubular.

4. The method of claim 1, wherein the expanded swellable material substantially forms a barrier between at least two subterranean zones.

5. The method of claim 2, wherein the fluid flows from at least one of the subterranean zones.

6. The method of claim 1, wherein the swellable material is integrated into a swellable packer.

7. The method of claim 1, wherein the nano particles comprise at least one of carbon nanotubes, carbon nano fibers, or nano clays.

8. The method of claim 1, wherein the nano particles comprise carbon nanotubes.

9. The method of claim 1, wherein the nano particles comprise less than 30% of the swellable material.

10. The method of claim 1, wherein at least a portion of the nano particles have a minimum dimension between 0.1 to 500 nanometers (nm).

11. The method of claim 1, wherein the nano particles include chemical functional groups.

12. The method of claim 1, wherein the carbon nano particles comprises carbon nanotubes.

13. The method of claim 1, wherein the fluid comprises water.

14. The method of claim 1, wherein the fluid comprises at least a hydrocarbon.

15. A method for producing a swellable element, comprising:
mixing at least a resin, and one or more curing agents with nano particles below a curing temperature associated with a polymer compound;
heating the mixture to the curing temperature associated with the polymer compound; and
molding the heated mixture to a specified shape configured to substantially form a an anchor.

16. The method of claim 15, wherein the mixture is molded adjacent to at least a portion of a surface of a tubing to form a layer of the swellable polymer compound.

17. The method of claim 15, wherein the nano particles comprise less than 30% of the mixture.

18. The method of claim 15, wherein the nano particles include chemical functional groups.

19. The method of claim 15, wherein the nano particles comprise carbon nanotubes.

20. The method of claim 15, wherein the nano particles comprise at least one of carbon nanotubes, carbon nano fibers, or nano clays.

21. The method of claim 15, wherein at least a portion of the nano particles have a diameter between 0.1 to 500 nanometers (nm).

22. An apparatus for substantially contacting subterranean formations, comprising:
a tubing with an outer surface, the tubing configured to longitudinally conduit fluid; and
a polymer compound adjacent at least a portion the outer surface of the tubing and operable to expand at least in a radial direction in response to at least an activating agent, the polymer compound comprising approximately less than 30% nano particles.

23. The apparatus of claim 22, wherein the nano particles comprise at least one of carbon nanotubes, carbon nano fibers, or nano clays.

24. The apparatus of claim 22, wherein the nano particles have an aspect ratio greater than 2.5.

25. An apparatus, comprising:
a tubing with a surface, the tubing configured to longitudinally conduit fluid; and
a polymer compound adjacent at least a portion the surface of the tubing and operable to expand at least in a radial direction in response to at least an activating agent, the polymer compound comprising nano particles with an aspect ratio at least 2.5.

26. The apparatus of claim 25, wherein the surface comprises an outer surface or an inner surface of the tubing.

27. The apparatus of claim 25, the polymer compound comprising less than 30% nano particles.

28. A well bore system, comprising:
a well bore intersecting a first subterranean zone and a second subterranean zone including resources; and
one or more swellable elements substantially contacting the non-production subterranean zone to substantially prevent fluid flow between the well bore the non-production subterranean zone, the one or more swellable elements including nano particles with an aspect ratio 2.5.

29. The well bore system of claim 28, wherein the one or more swellable elements comprise two swellable elements coupled by tubing, the coupled swellable elements configured to substantially impede the flow of fluid through an annulus of the tubing.

30. The well bore system of claim 28, wherein the nano particles comprise a least one of carbon nanotubes, carbon nano fibers, or nano clays.

31. The well bore system of claim 28, wherein the one of more swellable elements include a polymer compound embedded with the nano particles.

32. The well bore system of claim 28, wherein the first subterranean zone comprises a non-production subterranean zone, the second subterranean zone comprises a production subterranean zone.
